(19) United States
(12) Patent Application Publication
(10) Pub. No.: US 2022/0114203 A1
(43) Pub. Date: Apr. 14, 2022

(54) GENERATION OF VISUALIZATION DATA FROM UNSTRUCTURED DATA

(71) Applicant: International Business Machines Corporation, Armonk, NY (US)

(72) Inventors: Tzu-Chen Chao, Taipei City (TW); Juihsiang Huang, New Taipei City (TW); Shin Yu Wey, Taipei City (TW); Po-Cheng Chiu, Taipei (TW)

(21) Appl. No.: 17/067,847

(22) Filed: Oct. 12, 2020

(51) Int. Cl. G06F 16/35; G06F 40/216; G06F 40/30

(52) U.S. Cl. CPC G06F 16/358; G06F 40/30; G06F 40/216

(57) ABSTRACT

Machine logic (for example, software) for performing the following operations: (i) receiving an unstructured data set including information indicative of unstructured data that includes a plurality of first independent parameter values corresponding to a first independent parameter a plurality of first dependent parameter values corresponding to a first dependent parameter; (ii) parsing the unstructured data to identify the first independent parameter, the plurality of first independent parameter values, the first dependent parameter and the plurality of first dependent parameter values; (iii) selecting a first type of graph, from among a plurality of graph types, for visually representing the relationship; and (iv) generating a first graph data set that can be used to display a first graph of the first type which visually represents the relationship.

### BACKGROUND

The present invention relates generally to the field of parsing, summarization and visual presentation of data, especially numerical data.

The Wikipedia entry for “dependent and independent variables” (as of 4 Mar. 2020) states, in part, as follows: “Dependent and independent variables are variables in mathematical modeling, statistical modeling and experimental sciences. Independent variables are controlled inputs. Dependent variables represent the output or outcome resulting altering these inputs. Of the two, it is always the dependent variable whose variation is being studied, by altering inputs, also known as regressors in a statistical context. In an experiment, any variable that the experimenter manipulates can be called an independent variable. Models and experiments test the effects that the independent variables have on the dependent variables. Sometimes, even if their influence is not of direct interest, independent variables may be included for other reasons, such as to account for their potential confounding effect . . . . It is possible to have multiple independent variables or multiple dependent variables . . . . Variables may also be referred to by their form: continuous or categorical, which in turn may be binary/dichotomous, nominal categorical, and ordinal categorical, among others.”

It is known that the relationship between dependent variable(s) and independent variables can be represented by visual displays in the form of human understandable graphs. Some known types of graphs include: bar graphs, two dimensional plot graphs (also sometimes called abscissa versus ordinate graphs), three dimensional plot graphs and pie charts.

### SUMMARY

According to an aspect of the present invention, there is a method, computer program product and/or system that performs the following operations (not necessarily in the following order): (i) receiving an unstructured data set including information indicative of unstructured data that includes a plurality of first independent parameter values corresponding to a first independent parameter a plurality of first dependent parameter values corresponding to a first dependent parameter; (ii) parsing the unstructured data to identify the first independent parameter, the plurality of first independent parameter values, the first dependent parameter and the plurality of first dependent parameter values; (iii) selecting a first type of graph, from among a plurality of graph types, for visually representing the relationship between, at least, the plurality of first independent parameter values and the plurality of first dependent parameter values; and (iv) generating a first graph data set that can be used to display a first graph of the first type which visually represents the relationship between, at least, the plurality of first independent parameter values and the plurality of first dependent parameter values.

### BRIEF DESCRIPTION OF THE DRAWINGS

FIG. 1 is a block diagram view of a first embodiment of a system according to the present invention;

FIG. 2 is a flow chart showing a first embodiment method performed, at least in part, by the first embodiment system;

FIG. 3 is a block diagram showing a machine logic (for example, software) portion of the first embodiment system;

FIG. 4 is a screenshot view generated by the first embodiment system;

FIG. 5 is a block diagram view of a second embodiment of a system according to the present invention;

FIG. 6 is a flow chart showing a second embodiment method according to the present invention;

FIG. 7 is a flow chart showing a second embodiment method according to the present invention;

FIG. 8 is a block diagram view of a third embodiment of a system according to the present invention; and

FIG. 9 is a pie chart generated by an embodiment of the present invention.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (for example, light pulses passing through a fiber-optic cable), or electrical signals transmitted through a wire.

A “storage device” is hereby defined to be anything made or adapted to store computer code in a manner so that the computer code can be accessed by a computer processor. A storage device typically includes a storage medium, which is the material in, or on, which the data of the computer code is stored. A single “storage device” may have: (i) multiple discrete portions that are spaced apart, or distributed (for example, a set of six solid state storage devices respectively located in six laptop computers that collectively store a single computer program); and/or (ii) may use multiple storage media (for example, a set of computer code that is partially stored in as magnetic domains in a computer's non-volatile storage and partially stored in a set of semiconductor switches in the computer's volatile memory). The term “storage medium” should be construed to cover situations where multiple different types of storage media are used.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

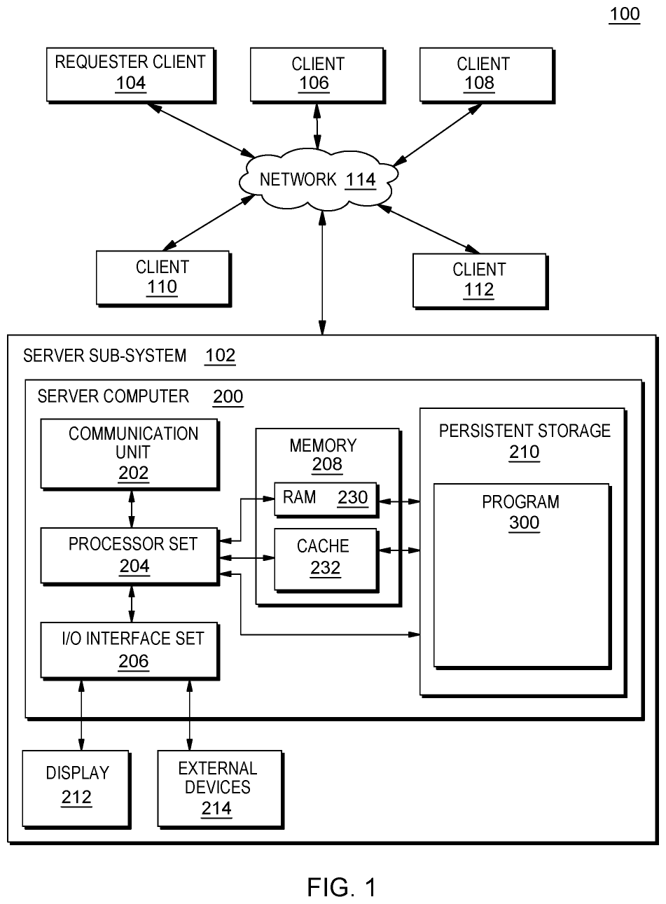

As shown in FIG. 1, networked computers system 100 is an embodiment of a hardware and software environment for use with various embodiments of the present invention. Networked computers system 100 includes: server subsystem 102 (sometimes herein referred to, more simply, as subsystem 102); client subsystems 104, 106, 108, 110, 112; and communication network 114. Server subsystem 102 includes: server computer 200; communication unit 202; processor set 204; input/output (I/O) interface set 206; memory 208; persistent storage 210; display 212; external device(s) 214; random access memory (RAM) 230; cache 232; and program 300.

Subsystem 102 may be a laptop computer, tablet computer, netbook computer, personal computer (PC), a desktop computer, a personal digital assistant (PDA), a smart phone, or any other type of computer (see definition of “computer” in Definitions section, below). Program 300 is a collection of machine readable instructions and/or data that is used to create, manage and control certain software functions that will be discussed in detail, below, in the Example Embodiment subsection of this Detailed Description section.

Subsystem 102 is capable of communicating with other computer subsystems via communication network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client subsystems.

Subsystem 102 is shown as a block diagram with many double arrows. These double arrows (no separate reference numerals) represent a communications fabric, which provides communications between various components of subsystem 102. This communications fabric can be implemented with any architecture designed for passing data and/or control information between processors (such as microprocessors, communications and network processors, etc.), system memory, peripheral devices, and any other hardware components within a computer system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for subsystem 102; and/or (ii) devices external to subsystem 102 may be able to provide memory for subsystem 102. Both memory 208 and persistent storage 210: (i) store data in a manner that is less transient than a signal in transit; and (ii) store data on a tangible medium (such as magnetic or optical domains). In this embodiment, memory 208 is volatile storage, while persistent storage 210 provides nonvolatile storage. The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202 provides for communications with other data processing systems or devices external to subsystem 102. In these examples, communications unit 202 includes one or more network interface cards. Communications unit 202 may provide communications through the use of either or both physical and wireless communications links. Any software modules discussed herein may be downloaded to a persistent storage device (such as persistent storage 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. I/O interface set 206 also connects in data communication with display 212. Display 212 is a display device that provides a mechanism to display data to a user and may be, for example, a computer monitor or a smart phone display screen.

In this embodiment, program 300 is stored in persistent storage 210 for access and/or execution by one or more computer processors of processor set 204, usually through one or more memories of memory 208. It will be understood by those of skill in the art that program 300 may be stored in a more highly distributed manner during its run time and/or when it is not running. Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### II. Example Embodiment

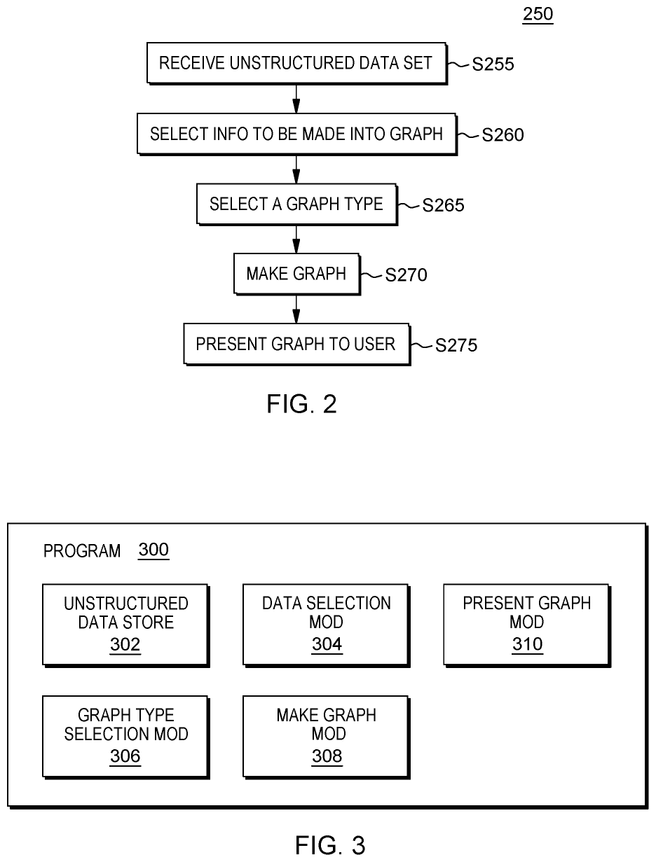

As shown in FIG. 1, networked computers system 100 is an environment in which an example method according to the present invention can be performed. As shown in FIG. 2, flowchart 250 shows an example method according to the present invention. As shown in FIG. 3, program 300 performs or controls performance of at least some of the method operations of flowchart 250. This method and associated software will now be discussed, over the course of the following paragraphs, with extensive reference to the blocks of FIGS. 1, 2 and 3.

Processing begins at operation S255, where unstructured data store 302 receives a set of unstructured data through communication network 114 from client subsystem 104. In this example, the unstructured data is as follows:

One day, after Papa Bear, Mama Bear and Baby Bear had made the porridge for their breakfast, and poured it into their porridge-bowls, they walked out into the wood while the porridge was cooling. While they were away a little girl called Goldilocks passed by the house, and looked in at the window. Seeing nobody in the house she opened the door and went in and saw the porridge on the table. She set about helping herself to the porridge. First she tasted the porridge of Papa Bear, and that was too hot for her. Next she tasted the porridge of Mama Bear, but that was too cold for her. And then she went to the porridge of Baby Bear, and tasted it, and that was neither too hot nor too cold, but just right, and she liked it so well that she ate it all up, every bit!

Processing proceeds to operation S260, where data selection module (“mod”) 304 performs the following sun-operations: (i) identifies the identity of the bears who respectively own the porridge bowls as an independent variable parameter; (ii) determines that the values for the independent variable are “Papa Bear,” “Mama Bear,” and “Baby Bear”; (iii) identifies porridge temperature as the dependent variable parameter; and (iv) determines that the values for the dependent parameter are “too hot,” “too cold,” and “just right.” It is noted that these variables are non-numerical (and in the case of the independent parameter non-ordered as well. Alternatively, both the independent and dependent variables may be numerical and/or ordered. As will be discussed in detail in the following sub-section of this Detailed Description section, various natural language parsing algorithms may be brought to bear in operation S260.

Processing proceeds to operation S265 where graph selection type mod 306 selects a type of graph to use for presenting the variable values, and their relationships to each other, in human understandable form and format. In this example, a bar graph type is the type of graph chosen.

Processing proceeds to operation S270 where make graph mod 308: (i) determines the relationship between the bear identities and the respectively corresponding porridge temperatures; and (ii) generates a bit map data set for displaying a bar graph to show these variable values and this relationship.

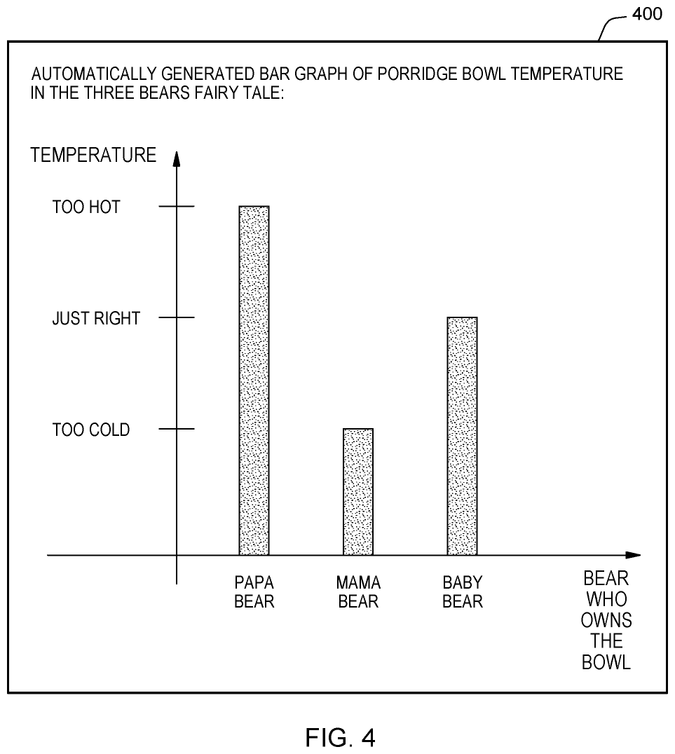

Processing proceeds to operation S275 where present graph mod 310 sends the graph bit map data set through communication network 114 to client subsystem 104, where the graph is displayed as screen shot 400 (see FIG. 4) to a human user who wants to quickly and easily understand the correlation between bear identity and porridge temperature.

### III. Further Comments and/or Embodiments

Some embodiments of the present invention recognize the following facts, potential problems and/or potential areas for improvement with respect to the current state of the art: (i) in today's world, people face lots of information all the time; (ii) for example, at work, people typically need to attend a lot of meetings to get works done; (iii) as a further example, at school, students typically need to read lots of books and really understand the content of them to pass the exams; (iv) there is typically a large amount of information to be gleaned from meetings and books; (v) people only have, at most, 24 hours a day to consume the information mentioned in the foregoing items on this list; (vi) being able to quickly get the main point of each meeting or each book is very important; (vii) in order to understand information efficiently, data visualization techniques can be leveraged to transform large amount of information into graphs that can be easily understand by humans; (viii) transforming structural numerical data into chart is easy; (ix) however, many of the times, people are actually handling unstructured data, such as e-mail messages, word processing documents, videos, photos, audio files, presentations, webpages and many other kinds of business documents; and/or (x) even when the data is structural numerical data, people still need to first have some understanding the background to decided which chart a given person should use to visualize the data.

Some embodiments of the present invention recognize the following facts, potential problems and/or potential areas for improvement with respect to the current state of the art: (i) there is too much information needed to be understood efficiently; (ii) displaying data, usually unistructural data, in a summary paragraph is still not a good way for people to understand; (iii) generating diagrams or charts by human is time consuming because people typically need to first have an understanding of the raw data as a whole and then start working on data visualization; (iv) data visualization is typically and time is typically precious; (v) it would be helpful to solve the problems mentioned above with computer systems and computerized methods; and/or (vi) there is a need for a system and method that can that can digest unstructured data and then turn it into some meaningful diagram/chart efficiently.

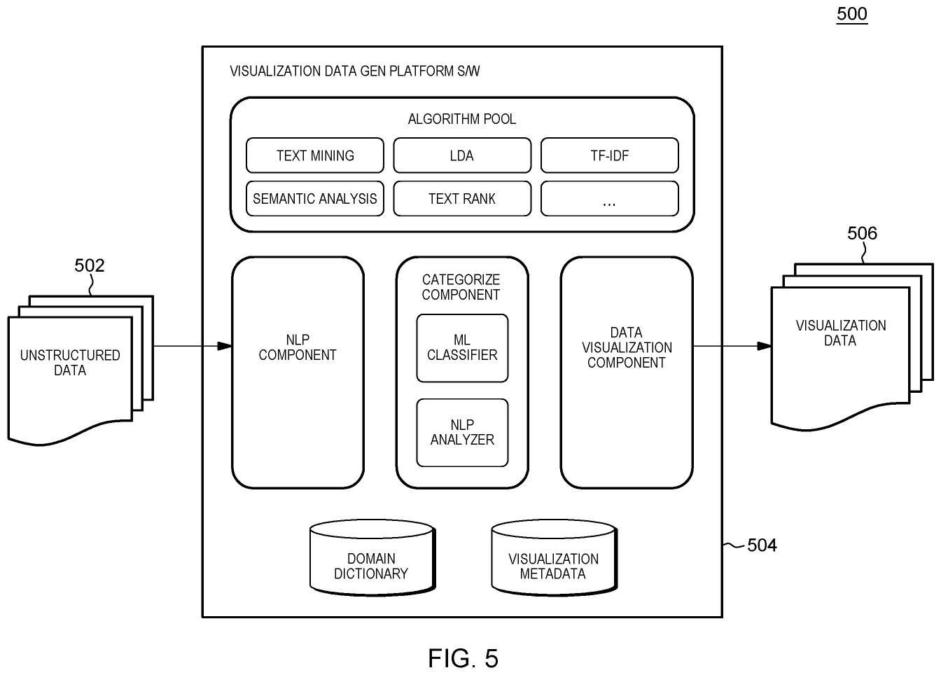

As shown in FIG. 5, system 500 a system generates visualization data 506 from unstructured data 502 using visualization data generation platform software 504. Software 504 runs on one or more computers (not shown in FIG. 5). The platform software consists of four major components as follows: (i) a NLP (natural language parsing) module is responsible for extracting keywords and filtering out unsuitable data; (ii) a categorization module classifies keywords, which are generated from NLP component, based on domain dictionary and then categorizes the classified keywords into structured data with relationship (in this embodiment, the structured data is commonly built as JSON (JavaScript Object Notation) format and it could be generated as multiple graphic styles according to a visualization metadata database); (iii) data visualization module is an engine to generate visual objects like chart, graph or diagram from structured data—the data visualization module is built by deep learning; and (iv) the algorithm pool is a library base including common machine learning algorithms, deep learning algorithms, and custom algorithms—this algorithm pool is mainly consumed by NLP and Categorization modules.

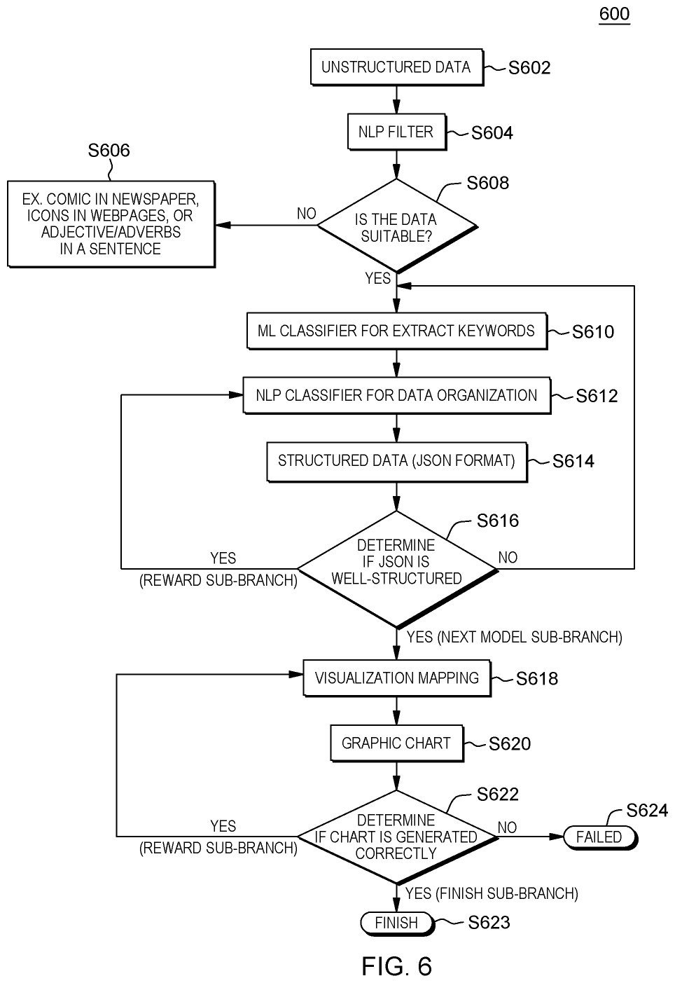

To improve the accuracy of this platform, supervised learning and reinforcement learning methodology are leveraged on each learning module. As shown in FIG. 6, flow chart 600 shows a method where supervised learning and reinforcement learning methodology are leveraged on each learning module. Flow chart 600 includes the following operations (with process flow among and between the operations as shown by arrows in FIG. 6): S602; S604; S606; S608; S610; S612; S614; S616; S618; S620; S622; S623; and S624.

Some embodiments of the present invention may include one, or more, of the following features, characteristics, operations and/or advantages: (i) transforms the text and data into a useful graph/chart that is easy to understand; (ii) includes a variety of learning algorithms to reinforce output visualization by the data visualization component with improved accuracy; (iii) a system to transfer text into a chart or diagram (herein called a “graph”); (iv) with NLP and semantic analysis, identifying which data is suitable for further stage and categorizing text into groups; (v) convert nonstructural data into JSON or csv format for modeling process; and/or (vi) using machine learning techniques for classification and select proper diagram to interpret the nonstructured data.

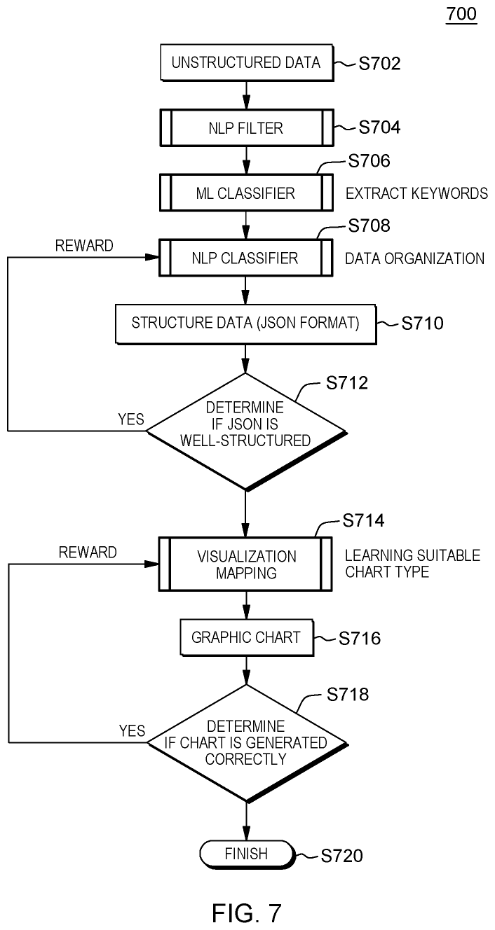

As shown in FIG. 7, flow chart 700 shows a method where accuracy is improved by using supervised learning with training and also reinforcement. Flow chart 700 includes the following operations (with process flow among and between the operations as shown by arrows in FIG. 7): S702; S704; S706; S708; S710; S712; S714; S716; S718; and S720. It is noted that the method represented by flow chart 700 of FIG. 7 is quite similar, but not identical, to the method represented in flow chart 600 of FIG. 6.

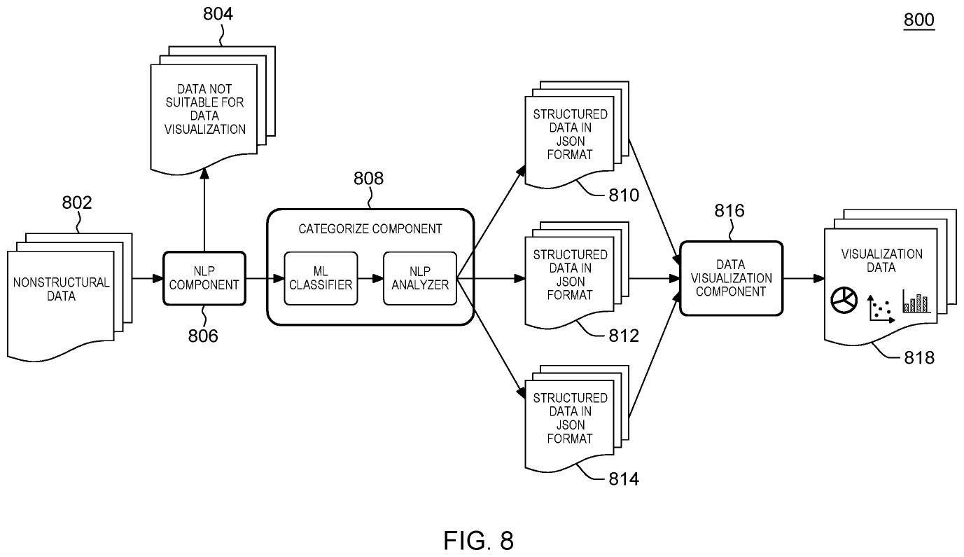

As shown in FIG. 8, system 800 includes: nonstructured data set 802; data not suitable for visualization data set 804; NLP component 806; categorize component 808; first structured data in JSON format data set 810; second structured data in JSON format 812; third structured data in JSON format 814; data visualization component 816; and visualization data 818. NLP component 806 will filter out data not suitable for data visualization (that is, data set 804). NLP component 806 uses various algorithms, such as Text Mining and Semantic Analysis algorithms.

Categorize component 808 will now be discussed in this paragraph. A Machine Learning classifier portion of component 808 uses a predefined dictionary to categorize information with different subjects into different groups. An NLP portion of component 808, uses various algorithms, such as, LDA, TF-IDF, or Text Rank, to do the text summarization.

With respect to data sets 810, 812 and 814, using predefined metadata and key words, such as % sign, $ sign, grow rate, and margin . . . etc., information can be separated into different JSON objects, which represent different types of charts. Data set 810 is data suitable for displaying as a pie chart. Data set 812 is data suitable for displaying as a bar chart and data set 814 is data suitable for displaying as a scatter plot.

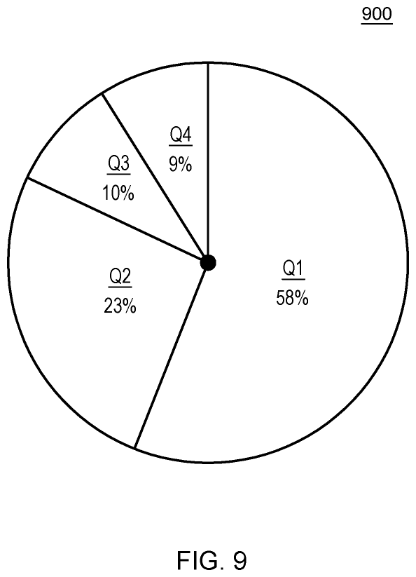

Pie chart 900 of FIG. 9 was generated, based on unstructured data, by an embodiment of the present invention and will now be discussed. In this example, the following text is received as input data:

Company A made $8.2 bn in quarter 1 of the year with help from an international backer, and dropped to 60% to only $3.2 bn in the second quarter. No further improvement in the following two quarters which only achieved $1.4 bn and $1.2 bn, respectively.
The machine logic of the present invention parses this text to identify: (i) the independent parameter, which is time; (ii) multiple parameter values for the independent parameter (specifically, Q1, Q2, Q3 and Q4); (iii) the dependent parameter, which is income of Company A; and (iv) multiple parameter values for the dependent parameter, specifically, $8,200,000,000 (also expressible as 58% of the yearly income), $3,200,000,000 (also expressible as 23% of the yearly income), $1,400,000,000 (also expressible as 10% of the yearly income) and $1,200,000,000 (also expressible as 9% of the yearly income). Pie chart 900 correlates the independent variable values to respective dependent variable values and expresses the result as a human understandable pie chart.

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

What is claimed is:

1. A computer-implemented method (CIM) comprising:
receiving an unstructured data set including information indicative of unstructured data that includes a plurality of first independent parameter values corresponding to a first independent parameter a plurality of first dependent parameter values corresponding to a first dependent parameter;
parsing the unstructured data to identify the first independent parameter, the plurality of first independent parameter values, the first dependent parameter and the plurality of first dependent parameter values;
selecting a first type of graph, from among a plurality of graph types, for visually representing the relationship between, at least, the plurality of first independent parameter values and the plurality of first dependent parameter values; and
generating a first graph data set that can be used to display a first graph of the first type which visually represents the relationship between, at least, the plurality of first independent parameter values and the plurality of first dependent parameter values.

2. The CIM of claim 1 further comprising:
displaying the first graph on display hardware using the first graph data set.

3. The CIM of claim 1 wherein:
the plurality of first independent parameter values are numerical values; and
the plurality of first dependent parameter values are numerical values.

4. The CIM of claim 1 wherein the first type of graph is one of the following graph types: bar graph, two dimensional plot graph, three dimensional plot graph and pie chart.

5. The CIM of claim 1 wherein the parsing of the unstructured data to identify the first independent parameter, the plurality of first independent parameter values, the first dependent parameter and the plurality of first dependent parameter values uses one, or more, of the following natural language parsing algorithms: latent Dirichlet allocation (LDA) algorithm, term frequency-inverse document frequency (TF-IDF) algorithm, text mining algorithm, semantic analysis algorithm and/or Text Rank algorithm.

6. The CIM of claim 1 wherein the selection of the first type of graph includes using predefined metadata and key words to separate information into different JavaScript Object Notation (JSON) objects.

7. A computer program product (CPP) comprising:
a set of storage device(s); and
computer code stored collectively in the set of storage device(s), with the computer code including data and instructions to cause a processor(s) set to perform at least the following operations:
receiving an unstructured data set including information indicative of unstructured data that includes a plurality of first independent parameter values corresponding to a first independent parameter a plurality of first dependent parameter values corresponding to a first dependent parameter,
parsing the unstructured data to identify the first independent parameter, the plurality of first independent parameter values, the first dependent parameter and the plurality of first dependent parameter values,
selecting a first type of graph, from among a plurality of graph types, for visually representing the relationship between, at least, the plurality of first independent parameter values and the plurality of first dependent parameter values, and
generating a first graph data set that can be used to display a first graph of the first type which visually represents the relationship between, at least, the plurality of first independent parameter values and the plurality of first dependent parameter values.

8. The CPP of claim 7 wherein the computer code further includes data and instructions for causing the processor(s) set to perform the following operation(s):
displaying the first graph on display hardware using the first graph data set.

9. The CPP of claim 7 wherein:
the plurality of first independent parameter values are numerical values; and
the plurality of first dependent parameter values are numerical values.

10. The CPP of claim 7 wherein the first type of graph is one of the following graph types: bar graph, two dimensional plot graph, three dimensional plot graph and pie chart.

11. The CPP of claim 7 wherein the parsing of the unstructured data to identify the first independent parameter, the plurality of first independent parameter values, the first dependent parameter and the plurality of first dependent parameter values uses one, or more, of the following natural language parsing algorithms: latent Dirichlet allocation (LDA) algorithm, term frequency-inverse document frequency (TF-IDF) algorithm, text mining algorithm, semantic analysis algorithm and/or Text Rank algorithm.

12. The CPP of claim 7 wherein the selection of the first type of graph includes using predefined metadata and key words to separate information into different JavaScript Object Notation (JSON) objects.

13. A computer system (CS) comprising:
a processor(s) set;
a set of storage device(s); and
computer code stored collectively in the set of storage device(s), with the computer code including data and instructions to cause the processor(s) set to perform at least the following operations:
receiving an unstructured data set including information indicative of unstructured data that includes a plurality of first independent parameter values corresponding to a first independent parameter a plurality of first dependent parameter values corresponding to a first dependent parameter,
parsing the unstructured data to identify the first independent parameter, the plurality of first independent parameter values, the first dependent parameter and the plurality of first dependent parameter values,
selecting a first type of graph, from among a plurality of graph types, for visually representing the relationship between, at least, the plurality of first independent parameter values and the plurality of first dependent parameter values, and
generating a first graph data set that can be used to display a first graph of the first type which visually represents the relationship between, at least, the plurality of first independent parameter values and the plurality of first dependent parameter values.

14. The CS of claim 13 wherein the computer code further includes data and instructions for causing the processor(s) set to perform the following operation(s):
displaying the first graph on display hardware using the first graph data set.

15. The CS of claim 13 wherein:
the plurality of first independent parameter values are numerical values; and
the plurality of first dependent parameter values are numerical values.

16. The CS of claim 13 wherein the first type of graph is one of the following graph types: bar graph, two dimensional plot graph, three dimensional plot graph and pie chart.

17. The CS of claim 13 wherein the parsing of the unstructured data to identify the first independent parameter, the plurality of first independent parameter values, the first dependent parameter and the plurality of first dependent parameter values uses one, or more, of the following natural language parsing algorithms: latent Dirichlet allocation (LDA) algorithm, term frequency-inverse document frequency (TF-IDF) algorithm, text mining algorithm, semantic analysis algorithm and/or Text Rank algorithm.

18. The CS of claim 13 wherein the selection of the first type of graph includes using predefined metadata and key words to separate information into different JavaScript Object Notation (JSON) objects.
